(19) United States
(12) Patent Application Publication
(10) Pub. No.: US 2025/0244580 A1
(43) Pub. Date: Jul. 31, 2025

(54) PROJECTION DEVICE AND HEAD-UP DISPLAY SYSTEM

(71) Applicant: Shanghai Tianma Microelectronics Co., Ltd., Shanghai (CN)

(72) Inventors: Yaodong WU, Shanghai (CN); Yang ZENG, Shanghai (CN); Yuan DING, Shanghai (CN)

(73) Assignee: Shanghai Tianma Microelectronics Co., Ltd., Shanghai (CN)

(21) Appl. No.: 19/072,154

(22) Filed: Mar. 6, 2025

(30) Foreign Application Priority Data
Oct. 29, 2024 (CN) 202411527276.5

(51) Int. Cl. G02B 27/01; G02B 5/18; G02B 27/00; G02F 1/1337

(52) U.S. Cl. CPC G02B 27/0101; G02B 5/1809; G02B 5/1823; G02B 5/1828; G02B 27/0093; G02B 27/0179; G02F 1/133769; G02B 2027/0114; G02B 2027/013; G02B 2027/0187

(57) ABSTRACT

A projection device includes an image source including a first image source, a second image source and a third image source, and the liquid crystal grating including three first liquid crystal gratings arranged at a first input end, a second input end and a third input end of a beam combiner respectively. A first color light beam emitted by the first image source is incident on the first liquid crystal grating, and is incident on the beam combiner after being modulated in a transmission direction by the first liquid crystal grating. A second color light beam emitted by the second image source is incident on the second liquid crystal grating, and is incident on the beam combiner after being modulated. A third color light beam emitted by the third image source is incident on the third liquid crystal grating, and is incident on the beam combiner after being modulated.

### CROSS-REFERENCE TO RELATED APPLICATION

This application claims priority to Chinese Patent Application No. 202411527276.5, filed on Oct. 29, 2024, the disclosure of which is incorporated herein by reference in its entirety.

### TECHNICAL FIELD

This application relates to the field of display technology, and in particular to a projection device and a head-up display system.

### BACKGROUND

Head-up display (HUD) is a transparent display technology that projects key driving information to a position in front of the driver's line of sight. The information may include vehicle speed, navigation instructions and warning signals. Through HUD, the driver can quickly obtain the required information without looking down at the dashboard. The working principle of HUD is mainly to project image information onto a semi-transparent reflector (such as a windshield) through a projector, and the reflector then reflects the image into the driver's line of sight. In this way, the driver can see the required driving information while keeping his line of sight unchanged.

At present, in the image source of the HUD system, different color light beams are each controlled by a display panel, the viewing angle can only be controlled by mechanical rotation, and finally, the beams are combined into the required color picture through a beam splitter prism. As a result, the HUD system is complex in structure, high in cost and poor in reliability.

### SUMMARY

A projection device and a head-up display system are provided according to the present application, and in the device and the system, a liquid crystal grating is provided, so that it is possible to modulate light beams of different colors emitted by an image source and realize light beam deflection. Such a projection device has a simple structure, low cost and high reliability.

In a first aspect, a projection device is provided according to embodiments of the present application, which includes an image source, a liquid crystal grating and a beam combiner. The image source includes a first image source, a second image source and a third image source, and the liquid crystal grating includes a first liquid crystal grating, a second liquid crystal grating and a third liquid crystal grating arranged at a first input end, a second input end and a third input end of the beam combiner respectively.

A first color light beam emitted by the first image source is incident on the first liquid crystal grating, and is incident on the beam combiner after being modulated in a transmission direction by the first liquid crystal grating.

A second color light beam emitted by the second image source is incident on the second liquid crystal grating, and is incident on the beam combiner after being modulated in a transmission direction by the second liquid crystal grating.

A third color light beam emitted by the third image source is incident on the third liquid crystal grating, and is incident on the beam combiner after being modulated in a transmission direction by the third liquid crystal grating.

The beam combiner combines the first color light beam, the second color light beam and the third color light beam to form a color image and emits light of the color image in a same direction.

In a second aspect, a head-up display system is further provided according to embodiments of the present application, which includes the projection device described in the first aspect.

### BRIEF DESCRIPTION OF DRAWINGS

FIG. 1 is a schematic structural diagram of a projection device in the related art;

FIG. 2 is a schematic structural diagram of a first kind of projection device according to an embodiment of the present application;

FIG. 3 is a schematic structural diagram of a second kind of projection device according to an embodiment of the present application;

FIG. 4 is a schematic structural diagram of a third kind of projection device according to an embodiment of the present application;

FIG. 5 is a schematic partial top view of a liquid crystal grating according to an embodiment of the present application;

FIG. 6 is a first schematic cross-sectional view of the liquid crystal grating corresponding to FIG. 5 along the section line A-A′ in FIG. 5;

FIG. 7 is a second schematic cross-sectional view of the liquid crystal grating corresponding to FIG. 5 along the section line A-A′ in FIG. 5;

FIG. 8 is a schematic cross-sectional view of the structure of a liquid crystal grating in the process of the inventor's research;

FIG. 9 is a schematic diagram showing voltage distribution of first grating electrodes and second grating electrodes of a liquid crystal grating in the process of the inventor's research;

FIG. 10 is a third schematic cross-sectional view of the liquid crystal grating corresponding to FIG. 5 along the section line A-A′ in FIG. 5;

FIG. 11 is a schematic diagram showing voltage distribution of first grating electrodes and second grating electrodes of a liquid crystal grating according to an embodiment of the present application;

FIG. 12 is a fourth schematic cross-sectional view of the structure of the liquid crystal grating corresponding to FIG. 5 along the section line A-A′ in FIG. 5;

FIG. 13 is a schematic diagram showing voltage distribution of first grating electrodes and second grating electrodes of another liquid crystal grating according to an embodiment of the present application;

FIG. 14 is a fifth schematic cross-sectional view of the structure of the liquid crystal grating corresponding to FIG. 5 along the section line A-A′ in FIG. 5; and

FIG. 15 is a schematic structural diagram of a head-up display system according to an embodiment of the present application.

### DETAILED DESCRIPTION

The present application is further described in detail hereinafter in conjunction with the accompanying drawings and embodiments. It can be understood that the embodiments described herein are only used to explain the present application, not to limit the present application. It should also be noted that, for the convenience of description, only the parts related to the present application, not all structures, are shown in the accompanying drawings.

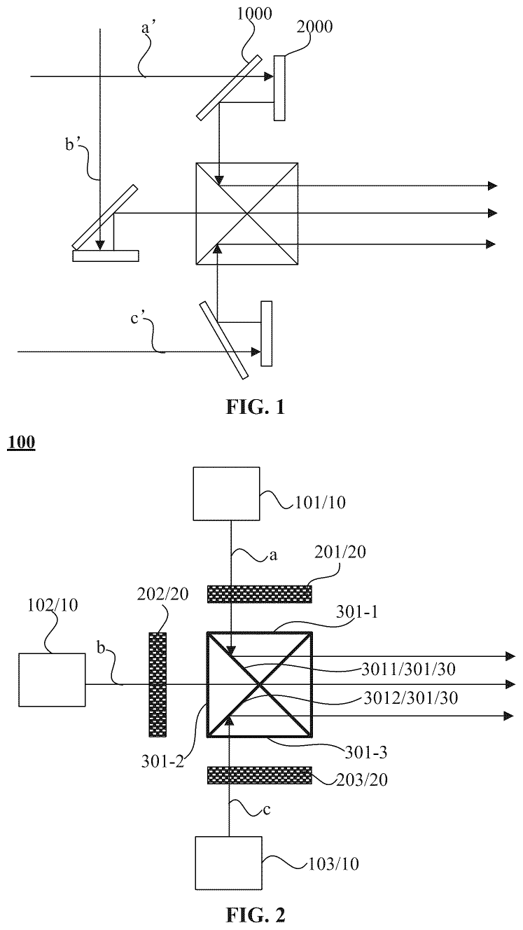

FIG. 1 is a schematic structural diagram of a projection device in the related art. As shown in FIG. 1, the inventor has found that a red light beam a′, a green light beam b′ and a blue light beam c′ emitted by an image source need to be deflected by reflectors 1000 and spatial light modulation modules 2000, that is, the viewing angle is controlled by mechanical rotation, and the modulated light beams of different colors pass through a beam splitter prism to form a color picture. Such a system is complex, costly and has poor reliability.

Based on the above research findings, the inventor has further developed the technical solution in the embodiments of the present application, in which, liquid crystal gratings are set between an image source and a beam combiner, so that the liquid crystal gratings can deflect the lights before being incident on the beam combiner, and realize the control of the light deflection angle, and then the light beams of different colors after deflection pass through the beam combiner to form a color image and emit in the same direction, and be incident on the human eyes. Thus, the user can view the driving information. Such a projection device has a simple structure, low cost and high reliability.

The above is the core idea of the present application. The technical solutions in the embodiments of the present application will be clearly and completely described hereinafter in conjunction with the drawings in the embodiments of the present application. Based on the embodiments of the present application, all other embodiments obtained by the person of ordinary skills in the art without creative work are within the scope of protection of the present application.

FIG. 2 is a schematic structural diagram of a first kind of projection device according to an embodiment of the present application. As shown in FIG. 2, the projection device 100 includes an image source 10, a liquid crystal grating 20 and a beam combiner 30. The image source 10 includes three members: a first image source 101, a second image source 102 and a third image source 103. The liquid crystal grating 20 includes three members: a first liquid crystal grating 201, a second liquid crystal grating 202 and a third liquid crystal grating 203 arranged at a first input end 301-1, a second input end 301-2 and a third input end 301-3 of the beam combiner 30 respectively. A first color light beam a emitted by the first image source 101 is incident on the first liquid crystal grating 201, and is incident on the beam combiner 30 after being modulated in a transmission direction by the first liquid crystal grating 201; a second color light beam b emitted by the second image source 102 is incident on the second liquid crystal grating 202, and is incident on the beam combiner 30 after being modulated in a transmission direction by the second liquid crystal grating 202; a third color light beam c emitted by the third image source 103 is incident on the third liquid crystal grating 203, and is incident on the beam combiner 30 after being modulated in a transmission direction by the third liquid crystal grating 203; and the beam combiner 30 combines the first color light beam a, the second color light beam b and the third color light beam c to form a color image and emits light of the color image in the same direction.

In an embodiment, the image source 10 can be understood as a picture generation unit (PGU) for emitting a light beam of at least one color. In this embodiment, the image source 10 includes three members: a first image source 101 emitting a first color light beam a, a second image source 102 emitting a second color light beam b and a third image source 103 emitting a third color light beam c. The colors of the light beams emitted by the three image sources are all different. Exemplarily, the first color light beam a may be a red light beam, the second color light beam b may be a green light beam, the third color light beam c may be a blue light beam, and the beam combiner 30 may output a color image.

In an embodiment, since the liquid crystal grating 20 can deflect light beams of different polarization states by different angles, the light beam can be deflected by controlling the arrangement of liquid crystal molecules in the liquid crystal grating 20, thereby achieving the deflection of the light beam emission direction without the aid of a mechanical structure. In the liquid crystal grating 20, the arrangement of the liquid crystal molecules may change with the effect of an electric field. In an embodiment, the liquid crystal grating 20 is arranged between the image source 10 and the beam combiner 30, members of the image source 10 and members of the liquid crystal grating 20 are in one-to-one correspondence, and members of the liquid crystal grating 20 and the input ends of the beam combiner 30 are in one-to-one correspondence, so that the three color light beams emitted by the three image sources 101, 102 and 103 are respectively incident on the three liquid crystal gratings 201, 202 and 203, and are separately incident on the beam combiner 30 after being modulated in transmission direction by members of the liquid crystal grating 20, that is, a first color light beam a emitted by the first image source 101 is incident on the first liquid crystal grating 201, and is then incident on the beam combiner 30 after its transmission direction is modulated by the first liquid crystal grating 201; a second color light beam b emitted by the second image source 102 is incident on the second liquid crystal grating 202, and is then incident on the beam combiner 30 after its transmission direction is modulated by the second liquid crystal grating 202; a third color light beam c emitted by the third image source 103 is incident on the third liquid crystal grating 203, and is then incident on the beam combiner 30 after its transmission direction is modulated by the third liquid crystal grating 203; and the beam combiner 30 combines the three color light beams to form a color image and emits the light of the color image in the same direction, and then the emitted light beam forming the color image is incident on the human eyes for users to view relevant information.

As a comparative example, in the embodiment of the present application, the liquid crystal grating 20 is used to replace the reflector and the spatial light modulation module in the related art, which, in one aspect, can reduce the number of members, thereby simplifying the structure of the projection device and realizing the miniaturization of the projection device, and in another aspect, achieves high reliability of light deflection by the liquid crystal grating.

In the projection device according to the embodiment of the present application, three different color light beams emitted by three image sources are respectively incident on the corresponding liquid crystal gratings, so that the liquid crystal gratings can deflect the light beams respectively, and the deflection angles of the light beams are controllable. The three different color light beams modulated by the liquid crystal gratings are combined by the beam combiner to form a color image and light of the image is emitted in the same direction, and then the emitted light beam forming the color image is incident on the human eyes, for the user to view the driving information. Such a projection device has a simple structure, low cost and high reliability.

Optionally, a grating period of the first liquid crystal grating 201, a grating period of the second liquid crystal grating 202 and a grating period of the third liquid crystal grating 203 are the same.

In an embodiment, the grating period of the liquid crystal grating 20 determines the deflection angle of the light. The grating period of the first liquid crystal grating 201, the grating period of the second liquid crystal grating 202 and the grating period of the third liquid crystal grating 203 are the same. Thus, in one aspect, the setting method is simple and the cost is low, and in another aspect, it is conducive to ensuring that the three different color light beams are modulated by members of the liquid crystal grating 20 respectively and combined by the beam combiner 30 to form a color image and light of the image is emitted in the same direction, thereby improving the projection effect of the projection device.

Optionally, the wavelength of the first color light beam a is λ1, the wavelength of the second color light beam b is λ2, the wavelength of the third color light beam c is λ3, the grating period of the first liquid crystal grating 201 is d1, the grating period of the second liquid crystal grating 202 is d2, the grating period of the third liquid crystal grating 203 is d3, and d1/λ1=d2/λ2=d3/λ3.

In an embodiment, the ratio of the grating period to the light wavelength affects the diffraction characteristics of the grating, including the diffraction angle and the diffraction efficiency. According to the grating equation dsin(θ)−mλ, where m is the diffraction order, it can be seen that the diffraction angle θ is related to the grating period d and the light wavelength λ, and the ratio of the grating period d to the light wavelength λ determines the deflection angle of the diffracted light.

In an embodiment, by setting d1/λ1=d2/λ2=d3/λ3, that is, if the wavelength λ1 of the first color light beam a is large, the grating period d1 of the first liquid crystal grating 201 is also large, and if the wavelength λ3 of the third color light beam c is small, the grating period d3 of the third liquid crystal grating 203 is also small, which is conducive to ensuring that the three different color light beams are combined by the beam combiner to form a color image and light of the image is emitted in the same direction, that is, the light angles are matched, thereby improving the display effect.

Optionally, λ1>λ2>λ3, that is, the first color light beam a can be a red light beam, the second color light beam b can be a green light beam, and the third color light beam c can be a blue light beam. To ensure that the three different color light beams are combined by the beam combiner 30 to form a color image and light of the image is emitted in the same direction, in addition, since λ1>λ2>λ3, according to d1/λ1=d2/λ2=d3/λ3, d1>d2>d3 can be set.

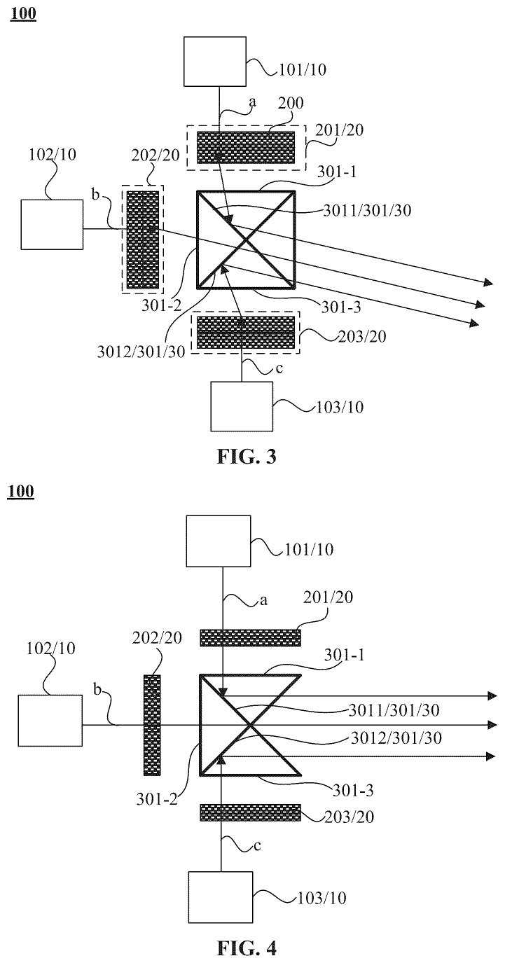

Optionally, FIG. 3 is a schematic structural diagram of a second projection device according to an embodiment of the present application. As shown in FIG. 3, at least one of the first liquid crystal grating 201, the second liquid crystal grating 202 and the third liquid crystal grating 203 includes at least two sub-liquid crystal gratings 200 stacked.

In an embodiment, it is taken as an example for explanation that the first liquid crystal grating 201, the second liquid crystal grating 202 and the third liquid crystal grating 203 each include two sub-liquid crystal gratings 200 stacked, that is, each member of the liquid crystal grating 20 includes two sub-liquid crystal gratings 200, in this way, the deflection angle of the liquid crystal grating to the light can be increased, the deflection effect can be improved and the display effect can be enhanced.

It is to be noted that each liquid crystal grating 20 can include three or more sub-liquid crystal gratings 200. Furthermore, any one of the first liquid crystal grating 201, the second liquid crystal grating 202 and the third liquid crystal grating 203 includes at least two sub-liquid crystal gratings 200, and it is also possible that any two of the first liquid crystal grating 201, the second liquid crystal grating 202 and the third liquid crystal grating 203 each include at least two sub-liquid crystal gratings 200. In this way, in one aspect, diversified setting of the projection device can be achieved, and in another aspect, the deflection angle of the liquid crystal grating to the light can be increased to enhance the display effect.

Optionally, FIG. 4 is a schematic structural diagram of a third kind of projection device according to an embodiment of the present application. As shown in FIG. 4, with continued reference to FIG. 2 and FIG. 4, the beam combiner 30 includes a color combining prism 301, and the color combining prism 301 includes a first color combining surface 3011 and a second color combining surface 3012. The first color combining surface 3011 reflects the first color light beam a and transmits the second color light beam b. The second color combining surface 3012 reflects the third color light beam c and transmits the second color light beam b. The first color light beam a is incident into the color combining prism 301 from the first input end 301-1 of the color combining prism 301, and is emitted from an output end of the color combining prism 301 after being reflected by the first color combining surface 3011. The second color light beam b is incident into the color combining prism 301 from the second input end 301-2 of the color combining prism 301, and is emitted from the output end of the color combining prism 301 after being transmitted through the first color combining surface 3011 and the second color combining surface 3012. The third color light beam c is incident into the color combining prism 301 from the third input end 301-3 of the color combining prism 301, and is emitted from the output end of the color combining prism 301 after being reflected by the second color combining surface 3012.

In an embodiment, the first color light beam a is incident into the color combining prism 301 from the first input end 301-1 of the color combining prism 301, and after being reflected by the first color combining surface 3011, the first color light beam a can be directly emitted from the output end of the color combining prism 301, or the light beam reflected by the first color combining surface 3011 can be emitted after being transmitted through the second color combining surface 3012. The third color light beam c is incident into the color combining prism 301 from the third input end 301-3 of the color combining prism 301, and after being reflected by the second color combining surface 3012, the incident third color light beam c can be directly emitted from the output end of the color combining prism 301, or the light beam reflected by the second color combining surface 3012 can be emitted after being transmitted through the first color combining surface 3011. The second color light beam b is incident into the color combining prism 301 from the second input end 301-2 of the color combining prism 301, and is emitted from the output end of the color combining prism 301 after being transmitted through the first color combining surface 3011 and the second color combining surface 3012. In this way, the three color light beams form a color image, and are emitted from the output end of the color combining prism 301 in the same direction, and then is incident on the human eyes.

Exemplarily, with continued reference to FIG. 2, the cross-sectional view of the color combining prism 301 can be a rectangle, and the first color combining surface 3011 and the second color combining surface 3012 can be the diagonals of the rectangle respectively.

Exemplarily, with continued reference to FIG. 4, the color combining prism 301 can be formed by gluing multiple triangular prisms.

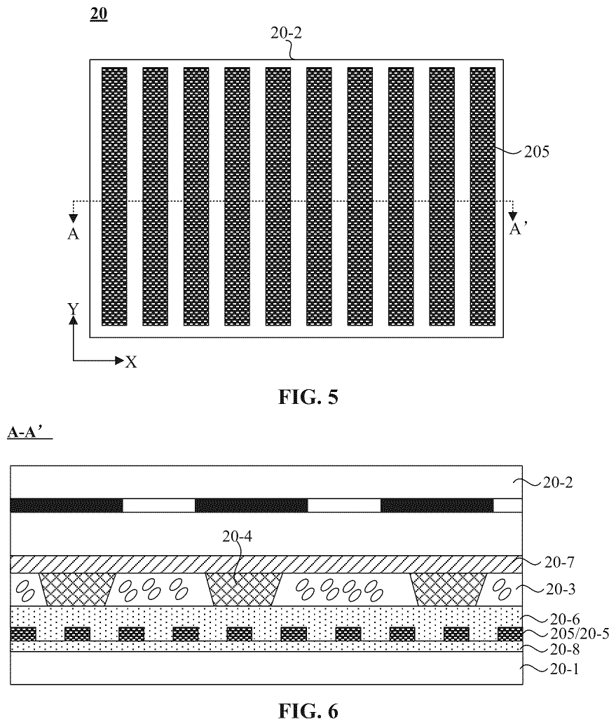

Optionally, FIG. 5 is a schematic partial top view of a liquid crystal grating according to an embodiment of the present application, and FIG. 6 is a first schematic cross-sectional view of the liquid crystal grating corresponding to FIG. 5 along the section line A-A′ in FIG. 5. As shown in FIG. 5 and FIG. 6, the liquid crystal grating 20 includes a first substrate 20-1 and a second substrate 20-2 arranged opposite to each other and a liquid crystal layer 20-3 located between the first substrate 20-1 and the second substrate 20-2. Multiple support structures 20-4 are included between the first substrate 20-1 and the second substrate 20-2. The first substrate 20-1 includes a driving electrode layer 20-5 on a side of the first substrate 20-1 facing the second substrate 20-2, and the driving electrode layer 20-5 includes multiple grating electrodes 205 arranged in a first direction (the X direction shown in the figure) and extending in a second direction (the Y direction shown in the figure). In an embodiment, the first substrate 20-1 further includes an auxiliary structure 20-6, at least part of the auxiliary structure 20-6 is located between at least part of the grating electrodes 205 and support structures 20-4, the first direction X and the second direction Y are each parallel to the plane on which the first substrate 20-1 is located, and the first direction X and the second direction Y intersect.

In an embodiment, the first substrate 20-1 and the second substrate 20-2 may be glass substrates for protecting the film structure in the liquid crystal grating. The liquid crystal layer 20-3 between the first substrate 20-1 and the second substrate 20-2 includes liquid crystal molecules. The multiple support structures 20-4 arranged between the first substrate 20-1 and the second substrate 20-2 are used to support the first substrate 20-1 and the second substrate 20-2 to form a filling space for the liquid crystal layer 20-3.

Exemplarily, the shape of the support structure 20-4 may be a column or a strip (such as a bank), etc. The embodiment of the present application is described by taking the shape of the support structure 20-4 as a truncated cone as an example. For example, the cross-sectional view of the support structure 20-4 is an inverted trapezoid.

In an embodiment, the driving electrode layer 20-5 includes multiple grating electrodes 205, that is, the grating electrodes 205 can be separately arranged. The second substrate 20-2 includes a common electrode layer 20-7 on a side facing the support structure 20-4. The common electrode layer 20-7 can be a common electrode arranged as an entire-surface electrode. There is a voltage difference between the common electrode and the grating electrode 205. In this way, the vertical electric field formed by the common electrode and the grating electrode 205 can drive the liquid crystal molecules in the liquid crystal layer 20-3 to rotate, thereby being able to deflect the light incident on the liquid crystal grating 20.

In an embodiment, the first substrate 20-1 further includes the auxiliary structure 20-6, at least part of the auxiliary structure 20-6 is located between at least part of the grating electrodes 205 and support structures 20-4, that is, by providing the auxiliary structure 20-6, the thickness of the inorganic layer between the first substrate 20-1 and the support structures 20-4 can be increased, thereby improving the pressure resistance of the liquid crystal grating 20, so that in the process of preparing or using the liquid crystal grating, when any support structure 20-4 is subjected to external pressure, the corresponding grating electrode 205 will not be broken, which is conducive to ensuring the stability of the liquid crystal grating.

In an embodiment, the auxiliary structure may be an insulating layer and/or a driving electrode layer. In a feasible embodiment, the auxiliary structure 20-6 may be an insulating layer, that is, the structure between the first substrate 20-1 and the support structure 20-4 is “insulating layer-driving electrode layer-insulating layer”. As another feasible embodiment, the auxiliary structure 20-6 may be a driving electrode layer, that is, the structure between the first substrate 20-1 and the support structure 20-4 is “insulating layer-driving electrode layer-insulating layer-driving electrode layer”. As another feasible implementation, the auxiliary structure 20-6 may be an insulating layer and a driving electrode layer, that is, the structure between the first substrate 20-1 and the support structure 20-4 is “insulating layer-driving electrode layer-insulating layer-driving electrode layer-insulating layer”, so that in one aspect, the pressure resistance of the liquid crystal grating can be improved, the stability and reliability of the liquid crystal grating can be ensured, and in another aspect, the diversified design of the liquid crystal grating can be realized.

Exemplarily, a side of the first substrate 20-1 facing the second substrate 20-2 and a side of the second substrate 20-2 facing the first substrate 20-1 may further include a dielectric layer. By setting the dielectric layer, in one aspect, the liquid crystal grating 20 can be protected from being damaged by the external environment, and in another aspect, the charges between the electrodes can be effectively isolated to prevent a leakage of electric charges and occurrence of electric arcs, so as to ensure that the liquid crystal grating 20 can work normally.

Optionally, with continued reference to FIG. 6, the liquid crystal grating 20 further includes a first insulating layer 20-8 located between the driving electrode layer 101 and the first substrate 10. The first insulating layer 20-8 is provided to improve the uniformity of the driving electrode layer and avoid defects in the driving electrode layer.

Optionally, with continued reference to FIG. 6, the auxiliary structure 20-6 includes an insulating layer.

In an embodiment, the auxiliary structure 20-6 includes an insulating layer, that is, the structure between the first substrate 20-1 and the support structure 20-4 can be “insulating layer-driving electrode layer-insulating layer”, so that a side of the support structure 20-4 facing the first substrate 20-1 is in direct contact with the insulating layer, the overall thickness of the inorganic layer can be increased by the auxiliary structure 20-6, and when the support structure 20-4 is subjected to external pressure, the auxiliary structure 20-6 can play a buffering role to prevent the grating electrodes 205 from being broken. Furthermore, in one aspect, the auxiliary structure 20-6 can cover the exposed surface of the grating electrodes 205, for example, protect the side of the grating electrodes 205 to avoid scratching the grating electrodes 205; and in another aspect, with the auxiliary structure 20-6 being in contact with the first insulating layer 20-8, an auxiliary support effect can be achieved, thereby improving the stability and reliability of the liquid crystal grating.

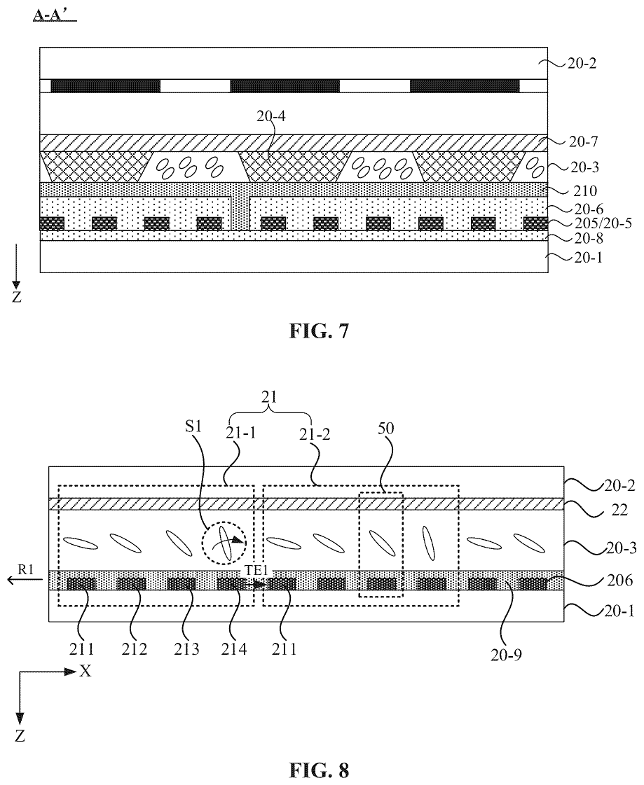

Optionally, FIG. 7 is a second schematic cross-sectional view of the liquid crystal grating corresponding to FIG. 5 along the section line A-A′ in FIG. 5. As shown in FIG. 7, the auxiliary structure 20-6 overlaps with at least two grating electrodes 205 in a third direction (Z direction as shown in the figure), and the third direction Z is the direction pointing from the second substrate 20-2 to the first substrate 20-1.

In an embodiment, in the third direction Z, the auxiliary structure 20-6 overlaps with at least two grating electrodes 205, that is, auxiliary structures 20-6 can be separately arranged, and each auxiliary structure 20-6 can have a width greater than or equal to the width of at least two grating electrodes 205, so as to completely cover the support structure 20-4, thereby improving the buffering capacity and bearing capacity, and reducing the probability of the grating electrodes 205 being disconnected when the support structure 20-4 is subjected to external pressure, which is conducive to improving the stability and reliability of the liquid crystal grating. Furthermore, in one aspect, the auxiliary structure 20-6 can cover the exposed surfaces of the grating electrodes 205, for example, protect the sides of the grating electrodes 205 to avoid scratching the grating electrodes 205; and in another aspect, with the auxiliary structure 20-6 in contact with the insulating layer 20-8, an auxiliary support effect can be achieved, thereby improving the stability and reliability of the liquid crystal grating. It is to be noted that in this embodiment, the auxiliary structure 20-6 is arranged as separate parts, rather than being arranged as an integral part, which is conducive to stress releasing and avoiding crack generation or crack transmission when the support structure 20-4 is under pressure.

It is to be noted that the liquid crystal grating 20 can further include an alignment layer 210, and the alignment layer 210 can be located between the auxiliary structure 20-6 and the liquid crystal molecules. Thus, in one aspect, the liquid crystal molecules can be prevented from contacting the grating electrodes 205, and in another aspect, the initial arrangement direction of the liquid crystal molecules can be controlled by the alignment layer 20-9. It can be understood that the side of the second substrate 20-2 facing the liquid crystal molecules and other drawings of the embodiments of the present application can include the alignment layer, though the alignment layer is not shown in the drawings of other embodiments.

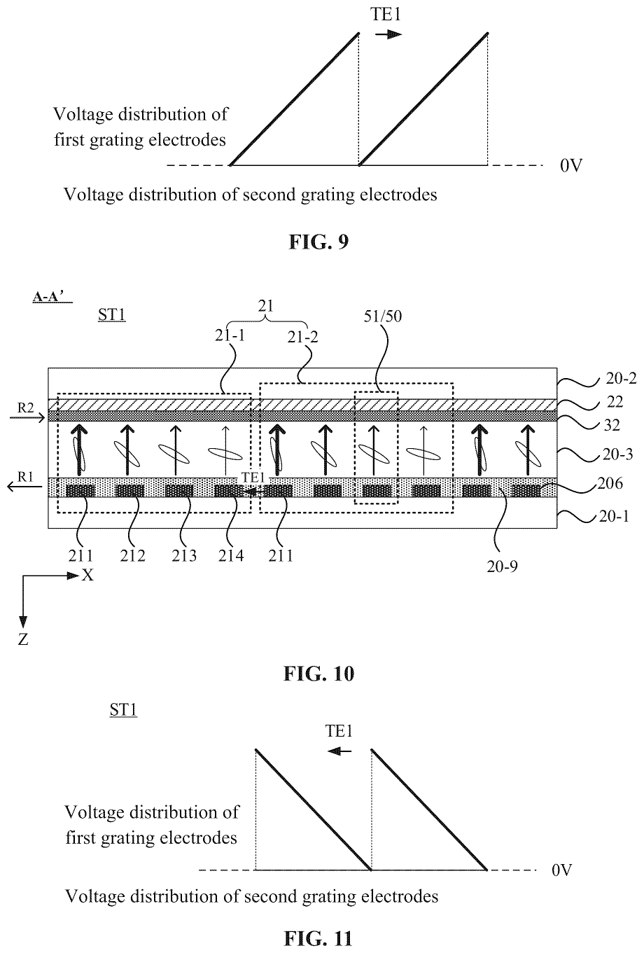

Optionally, FIG. 8 is a schematic cross-sectional view of the structure of a liquid crystal grating in the process of the inventor's research; and FIG. 9 is a schematic diagram showing voltage distribution of first grating electrodes and second grating electrodes of a liquid crystal grating in the process of the inventor's research, the liquid crystal grating 20 includes a first substrate 20-1 and a second substrate 20-2 arranged opposite to each other, and a liquid crystal layer 20-3 located between the first substrate 20-1 and the second substrate 20-2. The liquid crystal layer 20-3 includes liquid crystal molecules. The liquid crystal grating includes multiple grating units 21. The multiple grating units 21 are arranged in the first direction X, and the grating unit 21 includes multiple first grating electrodes 206 and a second grating electrode 22. The multiple first grating electrodes 206 are located between the first substrate 20-1 and the liquid crystal layer 20-3. The multiple first grating electrodes 206 are arranged spaced apart from each other in the first direction X. In the first direction X, two adjacent first grating electrodes 206 are spaced apart by a certain distance. The multiple grating units 21 share the same second grating electrode 22, and the second grating electrode 22 is a whole-surface electrode.

With continued reference to FIG. 8 and FIG. 9, the inventor has found through research that there is a voltage difference between the first grating electrode 206 and the second grating electrode 22, and the vertical electric field formed by the first grating electrode 206 and the second grating electrode 22 can drive the liquid crystal molecules to rotate. At least two first grating electrodes 206 with different voltages exist, thereby forming vertical electric fields of different strengths arranged in the first direction X. The vertical electric fields of different strengths cause the liquid crystal molecules to rotate by different angles, thereby forming a refractive index gradient, and forming multiple grating units 21 arranged in the first direction X. Therefore, the grating unit 21 can also include liquid crystal molecules. However, a horizontal electric field is formed between the first grating electrodes 206 with different voltages. The existence of the horizontal electric field will cause the liquid crystal molecules to produce a flexoelectricity and change their rotation behaviors, so that the liquid crystal molecules in the liquid crystal grating cannot flip according to the ideal situation, and the liquid crystal molecules rotate in the direction opposite to a pretilt angle, resulting in an antiphase domain problem.

With continued reference to FIG. 8 and FIG. 9, the inventor has found through research that some regions in the liquid crystal grating are in an undesirable state. The inventors further discovered that in the first direction X, a first electric field TE1 is formed between two first grating electrodes 206 that are located in two adjacent grating units 21 and are closest to each other. The first electric field TE1 is a horizontal electric field. The liquid crystal grating includes a first alignment layer 20-9, and the first alignment layer 20-9 is located between the liquid crystal layer 20-3 and the first grating electrodes 206. In the liquid crystal grating, there are some regions of the first alignment layer 20-9 whose alignment direction R1 is opposite to the electric field direction of the first electric field TE1. Under the combined influence of the first electric field TE1 and the vertical electric field, the liquid crystal molecules at the S1 region rotate in an arrow direction in FIG. 8 and flip in the opposite direction, thus generating a bubble-shaped antiphase domain in the S1 region. In an embodiment, the liquid crystal molecules at the S1 region are close to the first grating electrode 206. The first alignment layer 20-9 may be in direct contact with the first grating electrodes 206. In other embodiments, a protective layer may be provided between the first alignment layer 20-9 and the first grating electrodes 206. The first alignment layer 20-9 is located on the side of the protective layer away from the first grating electrodes 206. The protective layer provides a flat surface for the first alignment layer 20-9, thereby improving the flatness of the first alignment layer 20-9.

FIG. 10 is a third schematic cross-sectional view of the liquid crystal grating corresponding to FIG. 5 along the section line A-A′ in FIG. 5, and FIG. 11 is a schematic diagram showing voltage distribution of first grating electrodes and second grating electrodes of a liquid crystal grating according to an embodiment of the present application. Referring to FIG. 10 and FIG. 11, the liquid crystal grating 20 includes a first substrate 20-1 and a second substrate 20-2 arranged opposite to each other and a liquid crystal layer 20-3 located between the first substrate 20-1 and the second substrate 20-2, and the first substrate 20-1 includes first grating electrodes 206 and a first alignment layer 20-9 sequentially arranged on a side of the first substrate facing the liquid crystal layer 20-3. In a first state ST1, the liquid crystal grating 20 includes multiple grating units 21 arranged in the first direction X, and a grating unit 21 of the grating units 21 includes multiple first grating electrodes 206 arranged to be spaced apart from each other in the first direction X. In the first direction X, two adjacent first grating electrodes 206 are spaced apart by a certain distance. In the first direction X, a first electric field TE1 is formed between two first grating electrodes 206 located in two adjacent grating units 21 and closest to each other. The alignment direction R1 of the first alignment layer 20-9 is the same as the electric field direction of the first electric field TE1.

In an embodiment, the electric field direction of the first electric field TE1 is the same as the alignment direction R1 of the first alignment layer 20-9. The direction of electric field applied to the liquid crystal molecules adjacent to the first alignment layer 20-9 is oriented toward the alignment direction R1 of the first alignment layer 20-9, and will not be oriented in the opposite direction of the alignment direction of the first alignment layer 20-9. Thus, the liquid crystal molecules adjacent to the first alignment layer 20-9 will not flip in the opposite direction, which reduces the adverse effect of the horizontal electric field on the rotation of the liquid crystal molecules and mitigates the antiphase domain problem.

Exemplarily, with continued reference to FIG. 10 and FIG. 11, the liquid crystal grating 20 further includes a second grating electrode 22, and the second grating electrode 22 is located between the second substrate 20-2 and the liquid crystal layer 20-3. The vertical electric fields formed by the first grating electrodes 206 and the second grating electrode 22 can drive the liquid crystal molecules to rotate, thereby forming multiple grating units 21 repeatedly arranged in the first direction X. The liquid crystal grating is used for light diffraction and deflection.

Optionally, with continued reference to FIG. 10, the liquid crystal grating 20 further includes a second grating electrode 22, and the second grating electrode 22 is located between the second substrate 20-2 and the liquid crystal layer 20-3. In the same grating unit 21, multiple first electrode groups 51 arranged in the first direction X are included, and a first electrode group 51 of the first electrode groups 51 includes at least one first grating electrode 206 and at least one second grating electrode 22. In the same first electrode group 51, the first grating electrode 206 and the second grating electrode 22 at least partially overlap, and the voltage difference between the first grating electrode 206 and the second grating electrode 22 is a first voltage difference.

In an embodiment, the vertical electric field formed by the first voltage difference can drive the liquid crystal molecules to rotate. In an embodiment, the first voltage difference is the difference between the voltage of the first grating electrode 206 and the voltage of the second grating electrode 22 in the grating unit 21, that is, the first voltage difference is the voltage of the first grating electrode 206 minus the voltage of the second grating electrode 22.

Exemplarily, with continued reference to FIG. 10, one first electrode group 51 includes one first grating electrode 206 and one second grating electrode 22. A first voltage difference exists between the voltages of the first grating electrode 206 and the second grating electrode 22 in the same first electrode group 51. In other embodiments, one first electrode group 51 includes multiple first grating electrodes 206 and one second grating electrode 22.

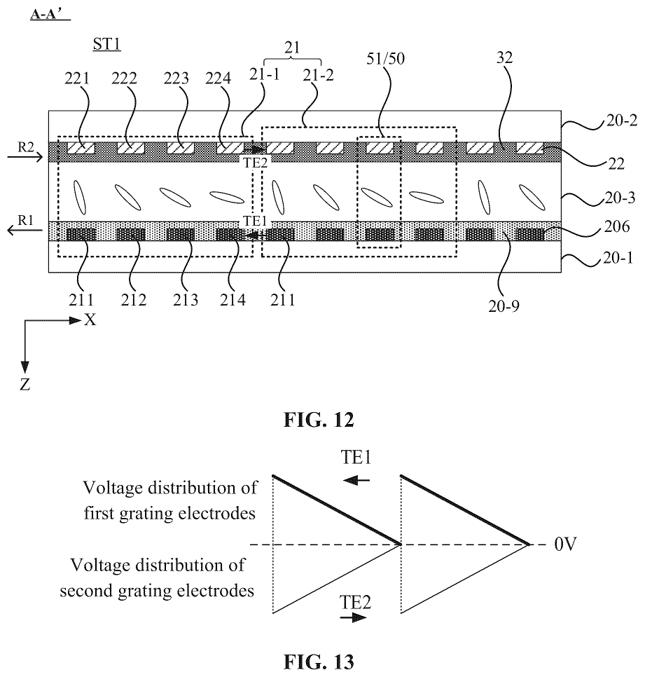

Optionally, FIG. 12 is a fourth schematic cross-sectional view of the structure of the liquid crystal grating corresponding to FIG. 5 along the section line A-A′ in FIG. 5, and FIG. 13 is a schematic diagram showing voltage distribution of first grating electrodes and second grating electrodes of another liquid crystal grating according to an embodiment of the present application. As shown in FIG. 12 and FIG. 13, the liquid crystal grating 20 further includes a second alignment layer 32, and the second alignment layer 32 is located between the second grating electrode 22 and the liquid crystal layer 20-3. In the first state ST1, the grating unit 20 includes multiple second grating electrodes 22 arranged to be spaced apart from each other in the first direction X. In the first direction X, a second electric field TE2 is formed between two second grating electrodes 22 located in two adjacent grating units 21 and closest to each other, and the alignment direction of the second alignment layer 32 is the same as the electric field direction of the second electric field TE2.

In an embodiment, the electric field direction of the second electric field TE2 is the same as an alignment direction R2 of the second alignment layer 32. The direction of electric field applied to the liquid crystal molecules adjacent to the second alignment layer 32 is oriented toward the alignment direction R2 of the second alignment layer 32, and will not be oriented in the opposite direction of the alignment direction of the second alignment layer 32. Thus, the liquid crystal molecules adjacent to the second alignment layer 32 will not flip in the opposite direction, which reduces the adverse effect of the horizontal electric field on the rotation of the liquid crystal molecules and mitigates the antiphase domain problem.

Exemplarily, with continued reference to FIG. 12 and FIG. 13, at least two first grating electrodes 206 with different voltages exist, and a horizontal electric field is generated between each two of the at least two first grating electrodes 206. At least two second grating electrodes 22 with different voltages exist, and a horizontal electric field is generated between each two of the at least two second grating electrodes 22. Thus, the horizontal electric fields are dispersed between the first grating electrodes 206 and between the second grating electrodes 22, and the horizontal electric fields are dispersed on the first substrate 20-1 and the second substrate 20-2, rather than concentrated on one substrate (the substrate includes the first substrate 20-1 and the second substrate 20-2), thereby reducing the horizontal electric field strength of a single substrate, reducing the adverse effect caused by the horizontal electric fields on the rotation of liquid crystal molecules and mitigating the antiphase domain problem.

Exemplarily, with continued reference to FIG. 12 and FIG. 13, in the same grating unit 21, at least two first grating electrodes 206 with different voltages exist, and at least two second grating electrodes 22 with different voltages exist. In the same grating unit 21, the horizontal electric fields are dispersed on the first substrate 20-1 and the second substrate 20-2, thereby reducing the adverse effect of the horizontal electric fields on the rotation of liquid crystal molecules and mitigating the antiphase domain problem.

Exemplarily, with continued reference to FIG. 8 and FIG. 9, the voltage of the first sub-first grating electrode 211 is +1V, the voltage of the second sub-first grating electrode 212 is +2V, the voltage of the third sub-first grating electrode 213 is +3V, and the voltage of the fourth sub-first grating electrode 214 is +4V. The voltage of the second grating electrode 22 is 0V. The voltage difference between the first sub-first grating electrode 211 and the second grating electrode 22 is 1V, the voltage difference between the second sub-first grating electrode 212 and the second grating electrode 22 is 2V, the voltage difference between the third sub-first grating electrode 213 and the second grating electrode 22 is 3V, and the voltage difference between the fourth sub-first grating electrode 214 and the second grating electrode 22 is 4V. The voltage difference between the fourth sub-first grating electrode 214 and the first sub-first grating electrode 211 in the adjacent grating unit 21 is 3V. When the horizontal electric field formed between the first grating electrodes 206 is large, if the alignment direction R1 of the first alignment layer 20-9 is opposite to the electric field direction of the first electric field TE1, the greater the electric field strength of the first electric field TE1, the easier it is for the liquid crystal molecules to fail to flip according to the ideal situation, and the liquid crystal molecules rotate in the direction opposite to the pretilt angle, resulting in an antiphase domain problem.

Exemplarily, referring to FIG. 12 and FIG. 13, the multiple second grating electrodes 22 include a first sub-second grating electrode 221, a second sub-second grating electrode 222, a third sub-second grating electrode 223, and a fourth sub-second grating electrode 224. The voltage of the first sub-first grating electrode 211 is +0.5V, the voltage of the second sub-first grating electrode 212 is +1V, the voltage of the third sub-first grating electrode 213 is +1.5V, and the voltage of the fourth sub-first grating electrode 214 is +2V. The voltage of the first sub-second grating electrode 221 is −0.5V, the voltage of the second sub-second grating electrode 222 is −1V, the voltage of the third sub-second grating electrode 223 is −1.5V, and the voltage of the fourth sub-second grating electrode 224 is −2V. The voltage difference formed between the first sub-first grating electrode 211 and the first sub-second grating electrode 221 is 1V, the voltage difference formed between the second sub-first grating electrode 212 and the second sub-second grating electrode 222 is 2V, the voltage difference formed between the third sub-first grating electrode 213 and the third sub-second grating electrode 223 is 3V, and the voltage difference formed between the fourth sub-first grating electrode 214 and the fourth sub-second grating electrode 224 is 4V. The voltage difference formed between the fourth sub-first grating electrode 214 and the first sub-first grating electrode 211 in the adjacent grating unit 21 is 1.5V. The voltage difference formed between the fourth sub-second grating electrode 224 and the first sub-second grating electrode 221 in the adjacent grating unit 21 is 1.5V. When the horizontal electric field formed between the first grating electrodes 206 is reduced, even if the alignment direction R1 of the first alignment layer 20-9 is opposite to the electric field direction of the first electric field TE1, the adverse effect of the horizontal electric field on the rotation of the liquid crystal molecules can be reduced, and the antiphase domain problem can be mitigated.

Exemplarily, referring to FIG. 12 and FIG. 13, in the grating units 21, the first grating electrodes 206 with the same ordinal number have the same voltage, and the second grating electrodes 22 with the same ordinal number have the same voltage. The voltage distribution laws of multiple first grating electrodes 206 in the grating units 21 are the same, and the voltage distribution laws of multiple second grating electrodes 22 in the grating units 21 are the same, so that the first grating electrodes 206 with the same voltage in multiple grating units 21 can be connected to the same power supply terminal, and the second grating electrodes 22 with the same voltage in multiple grating units 21 can be connected to the same power supply terminal, which reduces the number of power supply terminals. In an embodiment, the ordinal number of the first grating electrode 206 or the second grating electrode 22 in the grating unit 21 refers to which first grating electrode 206 or which second grating electrode 22 in the grating unit 21. In an embodiment, the voltage distribution law of the first grating electrodes 206 or the second grating electrodes 22 refers to the distribution law of the voltages of multiple first grating electrodes 206 or multiple second grating electrodes 22 in the first direction X.

Exemplarily, referring to FIG. 12 and FIG. 13, the grating unit 21 includes a first sub-grating unit 21-1 and a second sub-grating unit 21-2. The first sub-grating unit 21-1 and the second sub-grating unit 21-2 each include four electrode groups 50. One electrode group 50 (including the first electrode group 51) includes a first grating electrode 206 and a second grating electrode 22. In the grating unit 21, the four first grating electrodes 206 are arranged in sequence, and the four second grating electrodes 22 are arranged in sequence. The 1st first grating electrode 206 in the first sub-grating unit 21-1 and the 1st first grating electrode 206 in the second sub-grating unit 21-2 have the same voltage, and the second first grating electrode 206 in the first sub-grating unit 21-1 and the second first grating electrode 206 in the second sub-grating unit 21-2 have the same voltage. The first second grating electrode 22 in the first sub-grating unit 21-1 and the first second grating electrode 22 in the second sub-grating unit 21-2 have the same voltage, and the 2nd second grating electrode 22 in the first sub-grating unit 21-1 and the 2nd second grating electrode 22 in the second sub-grating unit 21-2 have the same voltage.

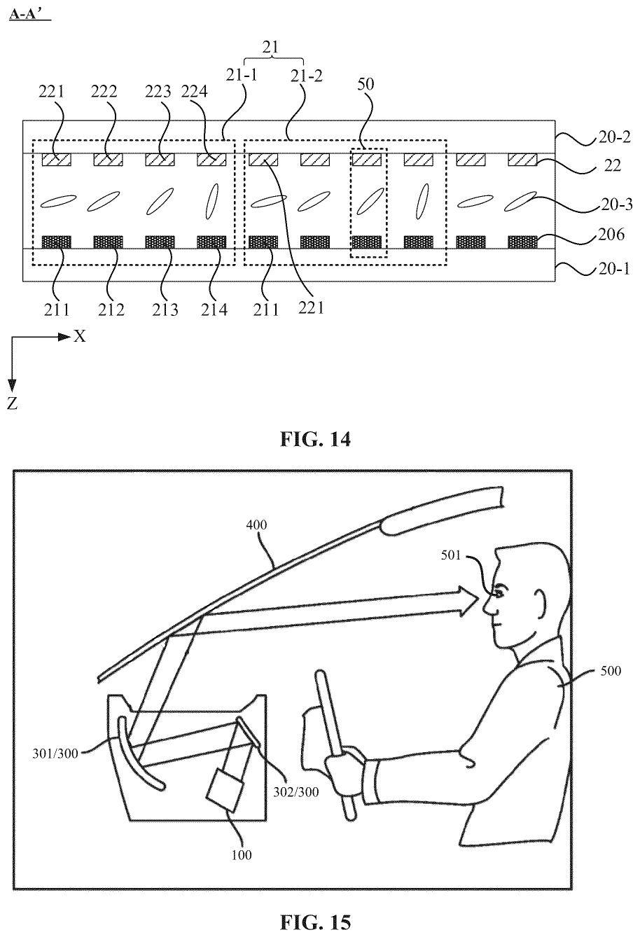

Optionally, FIG. 14 is a fifth schematic cross-sectional view of the structure of the liquid crystal grating corresponding to FIG. 5 along the section line A-A′ in FIG. 5. As shown in FIG. 14, the liquid crystal grating 20 includes a first substrate 20-1 and a second substrate 20-2 arranged opposite to each other and a liquid crystal layer 20-3 located between the first substrate 20-1 and the second substrate 20-2; and multiple grating units 21 which are arranged in the first direction X and include multiple first grating electrodes 206 and multiple second grating electrodes 22. The multiple first grating electrodes 206 are located between the first substrate 20-1 and the liquid crystal layer 20-3, and are arranged to be spaced apart from each other in the first direction X. The multiple second grating electrodes 22 are located between the second substrate 20-2 and the liquid crystal layer 20-3, and are arranged to be spaced apart from each other in the first direction X. At least two first grating electrodes 206 with different voltages exist, and at least two second grating electrodes 22 with different voltages exist.

In an embodiment, at least two first grating electrodes 206 with different voltages exist, and a horizontal electric field is generated between each two of the at least two first grating electrodes 206. At least two second grating electrodes 22 with different voltages exist, and a horizontal electric field is generated between each two of the at least two second grating electrodes 22. Thus, the horizontal electric fields are dispersed between the first grating electrodes 206 and between the second grating electrodes 22, and the horizontal electric fields are dispersed on the first substrate 20-1 and the second substrate 20-2, rather than being concentrated on one substrate (the substrate includes the first substrate 20-1 and the second substrate 20-2), thereby reducing the horizontal electric field strength of a single substrate, reducing the adverse effect caused by the horizontal electric fields on the rotation of the liquid crystal molecules and mitigating the antiphase domain problem.

Exemplarily, with continued reference to FIG. 14, the vertical electric fields formed by the first grating electrodes 206 and the second grating electrodes 22 can drive the liquid crystal molecules to rotate, thereby forming multiple grating units 21 repeatedly arranged in the first direction X. The liquid crystal grating is used for light diffraction and deflection. In an embodiment, the direction of the vertical electric fields can be the third direction Z or the opposite direction of the third direction Z.

Exemplarily, with continued reference to FIG. 14, in the same grating unit 21, at least two first grating electrodes 206 with different voltages exist, and at least two second grating electrodes 22 with different voltages exist. In the same grating unit 21, the horizontal electric fields are dispersed on the first substrate 20-1 and the second substrate 20-2, thereby reducing the adverse effect caused by the horizontal electric fields on the rotation of the liquid crystal molecules and mitigating the antiphase domain problem.

Optionally, with continued reference to FIG. 14, in the same grating unit 21, multiple electrode groups 50 arranged in the first direction X are included, and an electrode group 50 of the electrode groups 50 includes at least one first grating electrode 206 and at least one second grating electrode 22. In the same electrode group 50, the first grating electrode 206 and a second grating electrode 22 at least partially overlap, and the voltage difference between the first grating electrode 206 and the second grating electrode 22 is a first voltage difference.

In an embodiment, the vertical electric field formed by the first voltage difference can drive the liquid crystal molecules to rotate. In an embodiment, the first voltage difference is the difference between the voltage of the first grating electrode 206 and the voltage of the second grating electrode 22 in the grating unit 21, that is, the first voltage difference is the voltage of the first grating electrode 206 minus the voltage of the second grating electrode 22.

Exemplarily, with continued reference to FIG. 14, one electrode group 50 includes one first grating electrode 206 and one second grating electrode 22. A first voltage difference exists between the voltages of the first grating electrode 206 and the second grating electrode 22 in the same electrode group 50. In other embodiments, one electrode group 50 includes multiple first grating electrodes 206 and one second grating electrode 22.

In summary, in the projection device according to the embodiment of the present application, the three different color light beams emitted by the three image sources are respectively incident on the corresponding liquid crystal gratings, so that the liquid crystal gratings can deflect the light beams, and the deflection angles of the light beams are controllable. The three different color light beams modulated by the liquid crystal gratings are combined by the beam combiner to form a color image and light of the image is emitted in the same direction, and then the color image is incident on the human eyes, so that the user can refer to the driving information. In this way, the projection device has a simple structure, low cost and high reliability. Furthermore, at least one of the first liquid crystal grating, the second liquid crystal grating and the third liquid crystal grating includes at least two sub-liquid crystal gratings stacked, so that the deflection angle of the liquid crystal grating to the light can be increased, the deflection effect can be improved, and the display effect can be improved.

Based on the same inventive concept, a head-up display system is provided according to an embodiment of the present application, which includes the projection device described in the above embodiments. Therefore, the head-up display system according to the embodiment of the present application also has the above beneficial effects, which will not be repeated here.

FIG. 15 is a schematic structural diagram of a head-up display system according to an embodiment of the present application. As shown in FIG. 15, the head-up display system further includes an eye tracking device (not shown in the drawings), the eye tracking device is used to determine the observation position of the eyeballs 501 of the user 500, and the projection device 100 adjusts the signal for controlling the liquid crystal gratings according to the observation position of the eyeballs 501, to allow light of the image to be incident on the human eyes.

In an embodiment, the eye tracking device can detect the driver's line of sight and attention in real time, and then determine the observation position of the eyeballs 501 of the user 500. The projection device 100 adjusts the signal for controlling the liquid crystal grating according to the observation position of the eyeballs 501, so that light of the image can be ensured to be always in the user's field of view in one aspect, and the information required by the driver can be always monitored in another aspect, so as to display the most critical information at the right time and position, improve the efficiency of information transmission, and improve the user experience.

Optionally, with continued reference to FIG. 15, the head-up display system further includes at least one reflector 300, and light of the image output by the projection device is reflected by the reflector 300 and the windshield 400 and is incident on the human eyes.

In an embodiment, light of the image emitted by the projection device is reflected by the reflector 300 and is then incident on the windshield 400, and the windshield 400 reflects the light to the user's field of view, so that the user can see the relevant information.

Optionally, with continued reference to FIG. 15, the reflector 300 includes a first curved reflector 301 and a second curved reflector 302, and light of the image output by the projection device 100 is reflected by the first curved reflector 301, the second curved reflector 302 and the windshield 400 in sequence and is then incident on the human eyes.

In an embodiment, light of the image emitted by the projection device is reflected by the first curved reflector 301 to the second curved reflector 302, and then reflected by the second curved reflector 302 to the windshield 400, and finally reflected by the windshield 400 and incident on the human eyes. By setting the first curved reflector 301 and the second curved reflector 302, in one aspect, the transmission direction of the light can be changed to provide a longer projection distance and a larger field of view, and in another aspect, the first curved reflector 301 and the second curved reflector 302 can be adapted to the size and curvature of the windshield, which is conducive to the image being correctly reflected on the windshield and forming a clear virtual image within the driver's line of sight.

It is noted that the above is only preferred embodiments of the present application and the technical principles used. The person skilled in the art will understand that the present application is not limited to the embodiments described here, and that various obvious changes, readjustments, combinations and substitutions can be made by the person skilled in the art without departing from the scope of protection of the present application. Therefore, although the present application has been described in detail through the above embodiments, the present application is not limited to the above embodiments, and may include more other equivalent embodiments without departing from the concept of the present application. The scope of the present application is determined by the scope of the attached claims.

What is claimed is:

1. A projection device, comprising an image source, a liquid crystal grating and a beam combiner, wherein the image source comprises a first image source, a second image source and a third image source, and the liquid crystal grating comprises a first liquid crystal grating, a second liquid crystal grating and a third liquid crystal grating arranged at a first input end, a second input end and a third input end of the beam combiner respectively;
a first color light beam emitted by the first image source is incident on the first liquid crystal grating, and is incident on the beam combiner after being modulated in a transmission direction by the first liquid crystal grating;
a second color light beam emitted by the second image source is incident on the second liquid crystal grating, and is incident on the beam combiner after being modulated in a transmission direction by the second liquid crystal grating;
a third color light beam emitted by the third image source is incident on the third liquid crystal grating, and is incident on the beam combiner after being modulated in a transmission direction by the third liquid crystal grating; and
the beam combiner combines the first color light beam, the second color light beam and the third color light beam to form a color image and emits light of the color image in a same direction.

2. The projection device according to claim 1, wherein a grating period of the first liquid crystal grating, a grating period of the second liquid crystal grating and a grating period of the third liquid crystal grating are same.

3. The projection device according to claim 1, wherein a wavelength of the first color light beam is λ1, a wavelength of the second color light beam is λ2, a wavelength of the third color light beam is λ3, a grating period of the first liquid crystal grating is d1, a grating period of the second liquid crystal grating is d2, a grating period of the third liquid crystal grating is d3, and d1/λ1=d2/λ2=d3/λ3.

4. The projection device according to claim 3, wherein λ1>λ2>λ3.

5. The projection device according to claim 1, wherein at least one of the first liquid crystal grating, the second liquid crystal grating and the third liquid crystal grating comprises at least two sub-liquid crystal gratings stacked.

6. The projection device according to claim 1, wherein the beam combiner comprises a color combining prism, the color combining prism comprises a first color combining surface and a second color combining surface, the first color combining surface reflects the first color light beam and transmits the second color light beam, the second color combining surface reflects the third color light beam and transmits the second color light beam;
the first color light beam is incident into the color combining prism from the first input end of the color combining prism, and is emitted from an output end of the color combining prism after being reflected by the first color combining surface;
the second color light beam is incident into the color combining prism from the second input end of the color combining prism, and is emitted from the output end of the color combining prism after being transmitted by the first color combining surface and the second color combining surface; and
the third color light beam is incident into the color combining prism from the third input end of the color combining prism, and is emitted from the output end of the color combining prism after being reflected by the second color combining surface.

7. The projection device according to claim 1, wherein the liquid crystal grating comprises a first substrate and a second substrate arranged opposite to each other, and a liquid crystal layer located between the first substrate and the second substrate;
the projection device further comprises a plurality of support structures disposed between the first substrate and the second substrate;
the projection device further comprises a driving electrode layer on a side of the first substrate facing the second substrate, and the driving electrode layer comprises a plurality of grating electrodes arranged in a first direction and extending in a second direction; and
wherein the first substrate further comprises an auxiliary structure, at least part of the auxiliary structure is located between at least part of the grating electrodes and support structures, the first direction and the second direction are each parallel to a plane on which the first substrate is located, and the first direction and the second direction intersect.

8. The projection device according to claim 7, wherein the auxiliary structure comprises an insulating layer.

9. The projection device according to claim 7, wherein the auxiliary structure overlaps with at least two of the grating electrodes in a third direction, and the third direction is a direction pointing from the second substrate to the first substrate.

10. The projection device according to claim 1, wherein the liquid crystal grating comprises a first substrate and a second substrate arranged opposite to each other, and a liquid crystal layer located between the first substrate and the second substrate, the first substrate comprises first grating electrodes and a first alignment layer sequentially arranged on a side of the first substrate facing the liquid crystal layer; and in a first state, the liquid crystal grating comprises a plurality of grating units arranged in a first direction, and a grating unit of the plurality of grating units comprises a plurality of first grating electrodes arranged to be spaced apart from each other in the first direction; and
a first electric field is formed between two first grating electrodes located in two adjacent grating units and closest to each other in the first direction, and an alignment direction of the first alignment layer is same as an electric field direction of the first electric field.

11. The projection device according to claim 10, wherein the liquid crystal grating further comprises a second grating electrode, and the second grating electrode is located between the second substrate and the liquid crystal layer; and
in a same grating unit, a plurality of first electrode groups arranged in the first direction are comprised, and a first electrode group of the plurality of first electrode groups comprises at least one first grating electrode and at least one second grating electrode; and in a same first electrode group, the first grating electrode and the second grating electrode at least partially overlap, and the voltage difference between the first grating electrode and the second grating electrode is a first voltage difference.

12. The projection device according to claim 11, wherein the liquid crystal grating further comprises a second alignment layer, and the second alignment layer is located between the second grating electrode and the liquid crystal layer;
the grating unit comprises a plurality of second grating electrodes arranged to be spaced apart from each other in the first direction; and
a second electric field is formed between two second grating electrodes located in two adjacent grating units and closest to each other in the first direction, and an alignment direction of the second alignment layer is same as an electric field direction of the second electric field.

13. The projection device according to claim 1, wherein the liquid crystal grating comprises: a first substrate and a second substrate arranged opposite to each other and a liquid crystal layer located between the first substrate and the second substrate;
a plurality of grating units arranged in the first direction and comprising a plurality of first grating electrodes and a plurality of second grating electrodes; wherein the plurality of first grating electrodes are located between the first substrate and the liquid crystal layer and are arranged to be spaced apart from each other in the first direction; and the plurality of second grating electrodes are located between the second substrate and the liquid crystal layer and are arranged to be spaced apart from each other in the first direction; and
at least two first grating electrodes with different voltages exist, and at least two second grating electrodes with different voltages exist.

14. The projection device according to claim 13, wherein in a same grating unit, a plurality of electrode groups arranged in the first direction are comprised, and an electrode group of the plurality of electrode groups comprises at least one first grating electrode and at least one second grating electrode; and in a same electrode group, a first grating electrode and a second grating electrode at least partially overlap, and a voltage difference between the first grating electrode and the second grating electrode is a first voltage difference.

15. A head-up display system, comprising a projection device, wherein the projection device comprises an image source, a liquid crystal grating and a beam combiner, wherein the image source comprises a first image source, a second image source and a third image source, and the liquid crystal grating comprises a first liquid crystal grating, a second liquid crystal grating and a third liquid crystal grating arranged at a first input end, a second input end and a third input end of the beam combiner respectively;
a first color light beam emitted by the first image source is incident on the first liquid crystal grating, and is incident on the beam combiner after being modulated in a transmission direction by the first liquid crystal grating;
a second color light beam emitted by the second image source is incident on the second liquid crystal grating, and is incident on the beam combiner after being modulated in a transmission direction by the second liquid crystal grating;
a third color light beam emitted by the third image source is incident on the third liquid crystal grating, and is incident on the beam combiner after being modulated in a transmission direction by the third liquid crystal grating; and
the beam combiner combines the first color light beam, the second color light beam and the third color light beam to form a color image and emits light of the color image in a same direction.

16. The head-up display system according to claim 15, wherein a grating period of the first liquid crystal grating, a grating period of the second liquid crystal grating and a grating period of the third liquid crystal grating are same.

17. The head-up display system according to claim 15, wherein a wavelength of the first color light beam is λ1, a wavelength of the second color light beam is λ2, a wavelength of the third color light beam is λ3, a grating period of the first liquid crystal grating is d1, a grating period of the second liquid crystal grating is d2, a grating period of the third liquid crystal grating is d3, and d1/λ1=d2/λ2=d3/λ3.

18. The head-up display system according to claim 15, further comprising an eye tracking device, wherein the eye tracking device is configured to determine an observation position of user's eyeballs, and the projection device is configured to adjust a signal of the liquid crystal grating according to the observation position of the eyeballs to allow light of the image to be incident on human eyes.

19. The head-up display system according to claim 15, further comprising at least one reflector, wherein light of the image output by the projection device is incident on the human eyes after being reflected by the reflector and a windshield.

20. The head-up display system according to claim 19, wherein the reflector comprises a first curved reflector and a second curved reflector, and light of the image output by the projection device is reflected by the first curved reflector, the second curved reflector and the windshield in sequence and then is incident on human eyes.
